(19) United States
(12) Patent Application Publication
(10) Pub. No.: US 2018/0342216 A1
(43) Pub. Date: Nov. 29, 2018

(54) POTENTIAL TRANSFER CIRCUIT, DRIVING METHOD THEREOF AND DISPLAY PANEL USING THE SAME

(71) Applicants: HKC Corporation Limited, Shenzhen City, Guangdong (CN); Chongqing HKC Optoelectronics Technology Co., Ltd., Chongqing (CN)

(72) Inventor: Mingliang WANG, Chongqing (CN)

(21) Appl. No.: 15/555,784

(22) PCT Filed: Jul. 7, 2017
(86) PCT No.: PCT/CN2017/092141

§ 371 Date: Sep. 5, 2017

(30) Foreign Application Priority Data
May 27, 2017 (CN) 201710389714.X

(51) Int. Cl. G09G 3/36; G02F 1/1335

(52) U.S. Cl. CPC G09G 3/3648; G02F 1/133514; G09G 2310/08; G09G 2310/0286; G09G 2310/0289; G09G 3/3607

(57) ABSTRACT

The invention relates to a potential transfer circuit, driving method thereof and display panel using the same. The present potential transfer circuit comprises: a core circuit for providing an image signal; a controlling unit for extracting a controlling signal and a pixel signal from the image signal; a level rising unit for raising a voltage of the controlling signal and a voltage of the pixel signal to a simulation operating voltage; a signal output switch, including a controlling terminal electrically coupled to the level rising unit, and a first terminal electrically coupled to the core circuit; wherein a turn on speed of the signal output switch is controlled by a boost speed of the simulation operating voltage.

### BACKGROUND OF THE INVENTION

### Field of Invention

The present invention generally relates to a display field, especially a potential transfer circuit, driving method thereof and display panel using the same.

### Description of Related Art

In a modern technology development trend, flat LCD displays are more and more popular. The flat LCD displays have a benefit of a thin and light panel structure. The known driving circuit of the flat LCD display is mainly an external IC outside the display. However, this kind of outside IC design is not cost effective nor capable of making the displays thinner.

An LCD display apparatus usually includes a gate driving circuit, a source driving circuit, and a pixel array. There are a plurality of pixel circuits in the pixel array, wherein each pixel circuit turns on and off according to a scan signal provided by the gate driving circuit, and shows a data image according to a data signal provided by the source driving circuit. The gate driving circuit usually includes a multi-stage shift register. The multi-stage shift register includes a plurality of shift registers, wherein a scan signal is generated from the shift register at one stage to the shift register at a next stage, and exported to the pixel array to sequentially turn on the pixel circuit for receiving a data signal.

In a manufacturing process of the driving circuits, the gate driving circuit is directly built on an array substrate (named Gate On Array technology, GOA), to replace a driving chip made by an externally connected IC. This GOA technique can be applied on an edge of an LCD panel, for reducing the production steps and related cost, to make the display panel thinner.

In the GOA technique, a traditional gate IC is divided into a level IC and a shift register. The level IC is set on a driving board, and the shift register is set on a panel. Therefore, a space for the traditional gate IC is reduced to further reduce a bezel width of the display panel.

However, the shift register is electrically coupled to an active switch of a frame signal and a gate signal. When the active switch is on, an instantaneous pressure across the shift register is very large. A charge current spike will appear accordingly. Similarly, when an active switch electrically coupled to a frequency signal is on, a charge current spike will also appear. Since all gate lines are powered by the frequency signal, this kind of charge current spike will generate a large instantaneous output current of a potential transfer circuit, and also generate a large heat accompanying the large instantaneous output current. In addition, the two active switch above-mentioned will bear a greater current impact, ruining a reliability of circuits.

### SUMMARY OF THE INVENTION

In view of resolving the above technical issues, the present invention is to provide a potential transfer circuit for adjusting an instantaneous output current and reducing a greater current impact borne by the shift register.

The objects and technical solutions of the present invention are implemented by following technical ways and means. In one perspective, the present invention provides a potential transfer circuit, comprising: a core circuit for providing an image signal; a controlling unit, for extracting a controlling signal and a pixel signal from the image signal; a level rising unit for raising a voltage of the controlling signal and a voltage of the pixel signal to a simulation operating voltage; and a signal output switch, including a controlling terminal electrically coupled to the level rising unit, and a first terminal electrically coupled to the core circuit; wherein a turn on speed of the signal output switch is controlled by a boost speed of the simulation operating voltage.

The object and solution for the aforementioned technical problem according to the present invention can be also achieved by following embodiments and technical details.

In one embodiment of the present invention, a speed for the level rising unit boosting the simulation operating voltage is controlled by the controlling unit.

In one embodiment of the present invention, the core circuit provides a frequency signal to the first terminal of the signal output switch, and when the signal output switch turns on, the frequency signal is outputted from a second terminal of the signal output switch.

In one embodiment of the present invention, the signal output switch turns on slowly by raising the simulation operating voltage slowly, and a changing speed at a rising edge of a waveform of the frequency signal slows down accordingly, wherein the frequency signal is outputted from the second terminal of the signal output switch.

In one embodiment of the present invention, the signal output switch turns on slowly by raising the simulation operating voltage slowly, and a changing speed at a falling edge of a waveform of the frequency signal slows down accordingly, wherein the frequency signal is outputted from the second terminal of the signal output switch.

In one embodiment of the present invention, the controlling unit includes a digital-to-analog transfer unit for transferring a risen voltage of the pixel signal into a gray scale voltage and outputting the gray scale voltage to the shift register.

In one embodiment of the present invention, the controlling unit is electrically coupled to the shift register by a two-wire serial bus.

In another perspective, the present invention provides a display panel. The display panel comprises: a first substrate and a second substrate set opposite to each other; and a potential transfer circuit set on the first substrate or the second substrate. The potential transfer circuit comprises: a core circuit for providing an image signal; a controlling unit for extracting a controlling signal and a pixel signal from the image signal; a level rising unit for raising a voltage of the controlling signal and a voltage of the pixel signal to a simulation operating voltage; and a signal output switch, including a controlling terminal electrically coupled to the level rising unit, and a first terminal electrically coupled to the core circuit; wherein a turn on speed of the signal output switch is controlled by a boost speed of the simulation operating voltage.

In one embodiment of the present invention, a speed for the level rising unit boosting the simulation operating voltage is controlled by the controlling unit.

In one embodiment of the present invention, the core circuit provides a frequency signal to the first terminal of the signal output switch, and when the signal output switch turns on, the frequency signal is outputted from a second terminal of the signal output switch.

In one embodiment of the present invention, the signal output switch turns on slowly by raising the simulation operating voltage slowly, and a changing speed at a rising edge of a waveform of the frequency signal slows down accordingly, wherein the frequency signal is outputted from the second terminal of the signal output switch.

In one embodiment of the present invention, the signal output switch turns on slowly by raising the simulation operating voltage slowly, and a changing speed at a falling edge of a waveform of the frequency signal slows down accordingly, wherein the frequency signal is outputted from the second terminal of the signal output switch.

In one embodiment of the present invention, the controlling unit includes a digital-to-analog transfer unit for transferring a risen voltage of the pixel signal into a gray scale voltage and outputting the gray scale voltage to the shift register.

In one embodiment of the present invention, the controlling unit is electrically coupled to the shift register by a two-wire serial bus.

In another perspective, the present invention provides a driving method for a potential transfer circuit. The driving method for a potential transfer circuit comprises: providing an image signal by a core circuit; extracting a controlling signal and a pixel signal from the image signal by a controlling unit; raising a voltage of the controlling signal and a voltage of the pixel signal to a simulation operating voltage by a level rising unit; and adjusting a boost speed of the simulation operating voltage to control a turn on speed of a signal output switch.

The object and solution for the aforementioned technical problem according to the present invention can be also achieved by following embodiments and technical details.

In one embodiment of the present invention, the signal output switch turns on slowly by raising the simulation operating voltage slowly, and a changing speed at a rising edge and a falling edge of a waveform of the frequency signal slows down accordingly, wherein the frequency signal is outputted from the second terminal of the signal output switch.

In one embodiment of the present invention, a speed for the level rising unit boosting the simulation operating voltage is controlled by the controlling unit.

In one embodiment of the present invention, the core circuit provides a frequency signal to a first terminal of the signal output switch, and when the signal output switch turns on, the frequency signal is outputted from a second terminal of the signal output switch.

In one embodiment of the present invention, the controlling unit includes a digital-to-analog transfer unit for transferring a risen voltage of the pixel signal into a gray scale voltage and outputting the gray scale voltage to the shift register.

In one embodiment of the present invention, the controlling unit is electrically coupled to the shift register by a two-wire serial bus.

The present invention can adjust an instantaneous output current of a potential transfer circuit, slow down a current impact borne by the shift register, reduce power consumption of the potential transfer circuit and the shift register effectively, and improve a reliability of circuits at the same time. In addition, the present potential transfer circuit can be combined with other power integrated circuit by circuit integrated technique, so that circuit design can be simplified and cost can be reduced.

### BRIEF DESCRIPTION OF THE DRAWINGS

FIG 1a illustrates an exemplary liquid crystal display (LCD).

FIG. 1b illustrates a shift register circuit.

FIG. 1c illustrates an exemplary waveform of output signals of a potential transfer circuit.

FIG. 2a illustrates a potential transfer circuit according to one embodiment of the present invention.

FIG. 2b illustrates a waveform of output signals of a potential transfer circuit according to one embodiment of the present invention.

### DESCRIPTION OF THE PREFERRED EMBODIMENTS

The drawings as referred to throughout the description of the present invention are examples for implementing the objects of the present invention. The orientation words or terms used in the description of the present invention, such as “above”, “under”, “forward”, “backward”, “left”, “right”, “inner”, “outer”, “side”, etc. are examples in the drawings for illustrative purpose only, or just show the interrelations between the components, but not to be construed as limitations to the scope of the present invention.

The drawings and the description of the present invention are deemed to be examples but not limitations essentially. In the drawings, components or elements having similar or same structure are marked with the same numbers. In addition, sizes and thicknesses of every component or element are just examples, but not drawn according to actual scale and not read as limitations to the scope of the present invention.

In drawings of the present invention, sizes and thicknesses of layers, films, panels, or regions are emphasized for clearness, easy to describe and easy to understand. Therefore, some layers, films, or regions are emphasized but not drawn according to their actual scales. It is to be understood that, for example, when one of the components of layers, films, regions, or substrate are “on” another component of layers, films, regions, or substrate, the one of the components of layers, films, regions, or substrate could be adjacent on another component of layers, films, regions, or substrate directly, or there could be other inter-components of layers, films, regions, or substrate set therebetween.

Furthermore, in the description of the present invention, a word “comprising” or “including” is construed to comprise or include the related components but not exclude other components, except there is clearly opposite word or description in the present invention. And, in the description of the present invention, a word “on” is construed to be above or under a target component, but not construed to be limited on a top of the target component in vertical or gravity direction.

For further clarifying the technical solutions or functions of the present invention to implement the objects of the present invention, a potential transfer circuit driving and a display panel using the same, and their specific implementations, structures, features, and functions, according to a preferred embodiment of the present invention will be apparent from the following detailed description with reference to the accompanying drawings.

The display panel of the present invention can include, for example, a liquid crystal display (LCD) panel, an organic light-emitting diode (OLED) display panel, Quantum dot light-emitting diode (QLED) display panel, or other display panels. Taking a LCD display panel as an example, the LCD display panel includes an active array (thin film transistor, TFT) substrate, a color filter (CF) substrate, and a liquid crystal layer set between the active array substrate and the color filter (CF) substrate.

In some embodiments, the display panel of the present invention can be a curved display panel.

In some embodiments, an active array (thin film transistor, TFT) and a color filter (CF) substrate of the present invention can be formed on the same substrate.

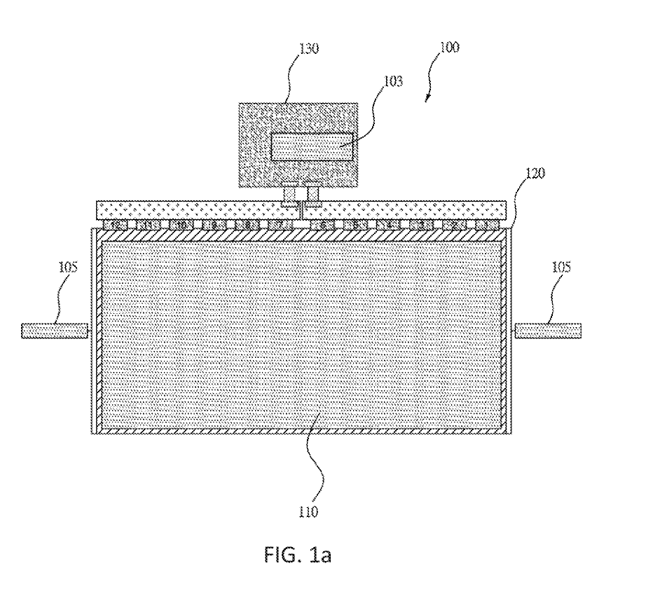

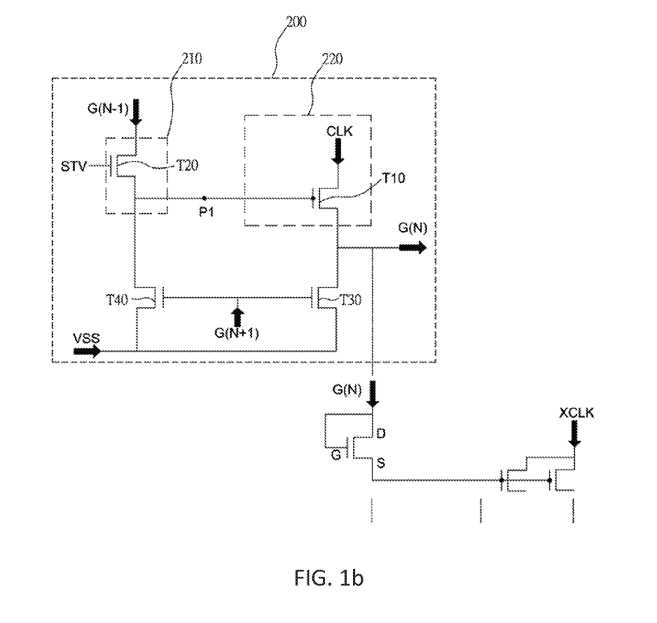

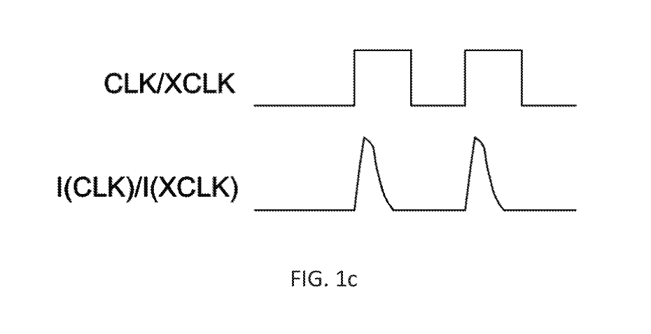

FIG. 1a illustrates an exemplary liquid crystal display (LCD). Please refer to FIG. 1a, a liquid crystal display (LCD) 100 of Gate On Array (GOA) technique includes a color filter (CF) substrate 110 and an active array substrate 120. A gate integrated circuit (gate IC) is divided into two parts, wherein one part is a potential transfer circuit (level shifter) 103 and another part is a shift register 105. The potential transfer circuit 103 is set on a driving circuit board 130, and the shift register 105 is set on an active array substrate 120. Generally speaking, since the shift register 105 occupies a very small area, a display panel according to a GOA technique can generally have an ultra-narrow bezel.

FIG. 1b illustrates a shift register circuit, which is generally improved and designed by a Thompson type circuit. Please refer to FIG. 1b, a shift register circuit 200 includes an input pulse signal circuit 210 and a frequency signal circuit 220. A frequency signal CLK and a frame signal STV are outputted by a potential transfer circuit 103. A gate signal G(N) is provided by gate lines in a display panel. A low default potential VSS is a low potential when the gate lines are turned off, and the frame signal STV(N) is a start signal.

When the frame signal STV inputs, a second switch T20 is turned on, a previous level gate signal G(N−1) charges a first node P1, and then a first switch T10 is turned on. When a frequency signal CLK is at a high potential, a current level gate signal G(N) will output a high potential, and this can turn on an active switch electrically connected with a Nth gate line of the display panel, and can be a start signal of a next level shift register circuit. When a next level gate signal G(N+1) outputs a high potential, a third switch T30 and a fourth switch T40 will be turned on at the same time, so that the current gate signal G(N) outputs a low default potential VSS and then the active switch of the Nth gate line of the display panel will be turned off. Therefore, an active switch of a previous gate line is turned off when an active switch of a next gate line is turned on. The above-mentioned operation can be continuously processed until all active switches of gate lines are turned on sequentially.

FIG. 1c illustrates an exemplary waveform of output signals of a potential transfer circuit. The waveform shown in FIG. 1c is a waveform of a frequency signal CLK/XCLK outputted from the circuit of FIG. 1a and a waveform of a frequency signal I(CLK)/I(XCLK) received by the shift register circuit of FIG. 1b. When the second switch 20 is on, since the previous level gate signal G(N−1) is at a high potential and a first node P1 is at a low default potential VSS, an instantaneous pressure across the second switch T20 is very large, so that a charge current spike appears. Similarly, when the first switch T10 is turned on, a charge current spike will also appear. Since all gate lines are powered by the frequency signal CLK, this charge current spike will generate a large instantaneous output current of the potential transfer circuit 103, and also generate a large heat accompanying the large instantaneous output current. Therefore, the first switch T10 and the second switch T20 will bear a greater current impact.

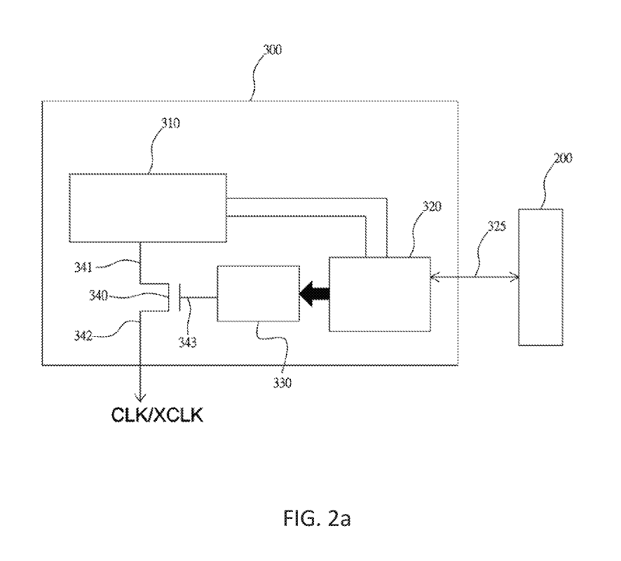

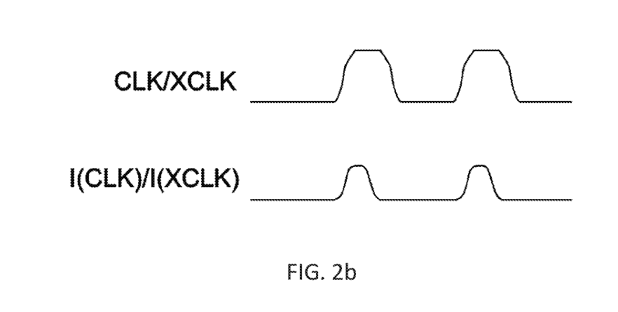

FIG. 2a illustrates a potential transfer circuit according to one embodiment of the present invention. Please refer to FIG. 2a, a potential transfer circuit 300 comprises: a core circuit 310 providing an image signal; a controlling unit 320 for extracting a controlling signal and a pixel signal from the image signal; a level rising unit (charge pump)330 for raising a voltage of the controlling signal and a voltage of the pixel signal to a simulation operating voltage; a signal output switch 340, including a controlling terminal 343 electrically coupled to the level rising unit 330, a first terminal 341 electrically coupled to the core circuit 310; wherein a turn on speed of the signal output switch 340 is controlled by a boost speed of the simulation operating voltage.

In some embodiments, a speed for the level rising unit 330 boosting the simulation operating voltage is controlled by the controlling unit 320.

In some embodiments, the core circuit 310 provides a frequency signal CLK to a first terminal 341 of the signal output switch 340. When the signal output switch 340 is turned on, the frequency signal CLK is then outputted through a second terminal 342 of the signal output switch 340.

FIG. 2b illustrates a waveform of output signals of a potential transfer circuit according to one embodiment of the present invention. The waveform shown in FIG. 2b is a waveform of a frequency signal CLK/XCLK outputted from the circuit of FIG. 2a and a waveform of a frequency signal I(CLK)/I(XCLK) received by the shift register circuit of FIG. 2a. Please refer to FIGS. 2a and 2b, in some embodiments, the signal output switch 340 is turned on slowly as the simulation operating voltage rising slowly, a changing speed at a rising edge and a falling edge of a waveform of the frequency signal CLK outputted from the second terminal 342 of the signal output switch 340 will slow down accordingly. The detailed description is as follows: a controlling unit 320 designed to be able to set a turn on speed of the signal output switch 340, and the controlling unit 320 extracting a controlling signal and a pixel signal from the image signal (these signals can be a digital logic signal or an analog signal according to different circuit types). Then the controlling signal and the pixel signal are transferred to the level rising unit 330 for amplifying voltage. That is, it is a process for the simulation operating voltage to rise up. The signal output switch 340 can be controlled by the simulation operating voltage. If the level rising unit 330 raises the simulation operating voltage slowly, the turn on speed of the signal output switch 340 will be also slowly, so that the changing speed at a rising edge and a falling edge of a waveform of the frequency signal CLK will slow down accordingly. That is, a process time increases. Therefore, when the frequency signal CLK charging the shift register 200, an instantaneous pressure will reduce and a current spike will also reduce, so that power consumption will reduce accordingly, and a reliability of the potential transfer circuit 300 and a reliability of the shift register 200 will be improved at the same time. In addition, the potential transfer circuit 300 can be combined with other power integrated circuit by circuit integrated technique, so that circuit design can be simplified and cost can be reduced.

In some embodiments, the controlling unit 320 further includes a digital-to-analog transfer unit for transferring a risen voltage of the pixel signal into a gray scale voltage, and for outputting the gray scale voltage to the shift register 200.

In some embodiments, the controlling unit 320 is electrically coupled to the shift register 200 by a two-wire serial bus 325.

In one embodiment of the present invention, a present driving method of potential transfer circuit comprises: providing an image signal by a core circuit 310; extracting a controlling signal and a pixel signal from the image signal by controlling unit 320; raising a voltage the controlling signal and a voltage of the pixel signal to a simulation operating voltage by the level rising unit 330; adjusting a boost speed of the simulation operating voltage for controlling a turn on speed of the signal output switch 340.

In one embodiment of the present invention, a present display panel comprises: a first substrate and a second substrate set opposite to each other; a liquid crystal layer set between the first substrate and the second substrate; a first polarizer film, disposed on an external surface of the first substrate; a second polarizer film, disposed on an external surface of the second substrate, wherein the polarization directions of the first polarizer film and the second polarizer film are parallel to each other; and a potential transfer circuit including all the technique features of the foregoing embodiments.

The present invention can adjust an instantaneous output current of a potential transfer circuit, slow down a current impact borne by the shift register, reduce power consumption of the potential transfer circuit and the shift register effectively, and improve a reliability of circuits at the same time. In addition, the present potential transfer circuit can be combined with other power integrated circuit by circuit integrated technique, so that circuit design can be simplified and cost can be reduced. The present design is simple and operates easily, and helps to improve a reliability of circuits. Therefore, the present invention can be applied to manufacture a variety of display panels with different size and its applications are highly flexible.

“In some embodiments of the present invention” and “In a variety of embodiments of the present invention” are used repeatedly through the description. They usually mean different embodiments. However, they can also mean the same embodiments. “Comprising”, “having” and “including” are synonyms, except it is noted to be different or has other meanings before and after its description.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. It is not limited to each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment

What is claimed is:

1. A potential transfer circuit, comprising:
a core circuit for providing an image signal;
a controlling unit, for extracting a controlling signal and a pixel signal from the image signal;
a level rising unit for raising a voltage of the controlling signal and a voltage of the pixel signal to a simulation operating voltage; and
a signal output switch, including a controlling terminal electrically coupled to the level rising unit, and a first terminal electrically coupled to the core circuit;
wherein a turn on speed of the signal output switch is controlled by a boost speed of the simulation operating voltage.

2. The potential transfer circuit according to claim 1, wherein a speed for the level rising unit boosting the simulation operating voltage is controlled by the controlling unit.

3. The potential transfer circuit according to claim 1, wherein the core circuit provides a frequency signal to the first terminal of the signal output switch, and when the signal output switch turns on, the frequency signal is outputted from a second terminal of the signal output switch.

4. The potential transfer circuit according to claim 3, wherein the signal output switch turns on slowly by raising the simulation operating voltage slowly, and a changing speed at a rising edge of a waveform of the frequency signal slows down accordingly, wherein the frequency signal is outputted from the second terminal of the signal output switch.

5. The potential transfer circuit according to claim 3, wherein the signal output switch turns on slowly by raising the simulation operating voltage slowly, and a changing speed at a falling edge of a waveform of the frequency signal slows down accordingly, wherein the frequency signal is outputted from the second terminal of the signal output switch.

6. The potential transfer circuit according to claim 1, wherein the controlling unit includes a digital-to-analog transfer unit for transferring a risen voltage of the pixel signal into a gray scale voltage and outputting the gray scale voltage to a shift register.

7. The potential transfer circuit according to claim 1, wherein the controlling unit is electrically coupled to the shift register by a two-wire serial bus.

8. A display panel, comprising:
a first substrate;
a second substrate set opposite to the first substrate; and
a potential transfer circuit set on the first substrate or the second substrate, the potential transfer circuit comprising:
a core circuit for providing an image signal;
a controlling unit for extracting a controlling signal and a pixel signal from the image signal;
a level rising unit for raising a voltage of the controlling signal and a voltage of the pixel signal to a simulation operating voltage; and
a signal output switch, having a controlling terminal electrically coupled to the level rising unit, and a first terminal electrically coupled to the core circuit;
wherein a turn on speed of the signal output switch is controlled by a boost speed of the simulation operating voltage.

9. The display panel according to claim 8, wherein a speed for the level rising unit boosting the simulation operating voltage is controlled by the controlling unit.

10. The display panel according to claim 8, wherein the core circuit provides a frequency signal to the first terminal of the signal output switch, and when the signal output switch turns on, the frequency signal is outputted from a second terminal of the signal output switch.

11. The display panel according to claim 10, wherein the signal output switch turns on slowly by raising the simulation operating voltage slowly, and a changing speed at a rising edge of a waveform of the frequency signal slows down accordingly, wherein the frequency signal is outputted from the second terminal of the signal output switch.

12. The display panel according to claim 10, wherein the signal output switch turns on slowly by raising the simulation operating voltage slowly, and a changing speed at a falling edge of a waveform of the frequency signal slows down accordingly, wherein the frequency signal is outputted from the second terminal of the signal output switch.

13. The display panel according to claim 8, wherein the controlling unit includes a digital-to-analog transfer unit for transferring a risen voltage of the pixel signal into a gray scale voltage and outputting the gray scale voltage to the shift register.

14. The display panel according to claim 8, wherein the controlling unit is electrically coupled to the shift register by a two-wire serial bus.

15. A driving method for a potential transfer circuit, the driving method comprising:
providing an image signal by a core circuit;
extracting a controlling signal and a pixel signal from the image signal by a controlling unit;
raising a voltage of the controlling signal and a voltage of the pixel signal to a simulation operating voltage by a level rising unit; and
adjusting a boost speed of the simulation operating voltage to control a turn on speed of a signal output switch.

16. The driving method of potential transfer circuit according to claim 15, wherein a speed that the level rising unit boosting the simulation operating voltage is controlled by the controlling unit.

17. The driving method of potential transfer circuit according to claim 15, wherein the core circuit provides a frequency signal to a first terminal of the signal output switch, and when the signal output switch turns on, the frequency signal is outputted from a second terminal of the signal output switch.

18. The driving method of potential transfer circuit according to claim 15, wherein the signal output switch turns on slowly by raising the simulation operating voltage slowly, and a changing speed at a rising edge and a falling edge of a waveform of the frequency signal slows down accordingly, wherein the frequency signal is outputted from the second terminal of the signal output switch.

19. The driving method of potential transfer circuit according to claim 15, wherein the controlling unit includes a digital-to-analog transfer unit for transferring a risen voltage of the pixel signal into a gray scale voltage and outputting the gray scale voltage to the shift register.

20. The driving method of potential transfer circuit according to claim 15, wherein the controlling unit is electrically coupled to the shift register by a two-wire serial bus.
